(19) United States
(12) Patent Application Publication
(10) Pub. No.: US 2022/0357929 A1
(43) Pub. Date: Nov. 10, 2022

(54) ARTIFICIAL INTELLIGENCE INFUSED ESTIMATION AND WHAT-IF ANALYSIS SYSTEM

(71) Applicant: Accenture Global Solutions Limited, Dublin (IE)

(72) Inventors: Koushik M. Vijayaraghavan, Chennai (IN); Priya Athreyee, Chennai (IN); Koustuv Jana, Bangalore (IN); Pradeep Senapati, Bangalore (IN); Kamakshi Girish, Bangalore (IN); Dibyendu Chattopadhyay, South Dumdum (IN)

(21) Appl. No.: 17/308,834

(22) Filed: May 5, 2021

(51) Int. Cl. G06F 8/10; G06F 8/75; G06N 3/04

(52) U.S. Cl. CPC G06F 8/10; G06F 8/75; G06N 3/0454

(57) ABSTRACT

A system and method for estimating software project delivery details is disclosed. The disclosed method and system accurately predicts project delivery details (e.g., person-days, effort, full-time equivalent (FTE), etc.) from input text (e.g., text describing a software project requirements) and project input parameters (e.g., variables, such as logical entities, transactions, individual/team proficiency, team level, duration of project, technology, industry domain, etc.) corresponding to a project scenario. In addition to predicting project delivery details, the disclosed system and method can provide a what-if analysis engine that allows a user to understand the possibilities of project scenarios having certain output.

### TECHNICAL FIELD

The present disclosure generally relates to software product development. More specifically, the present disclosure relates to systems and methods for artificial intelligence infused automated estimation in software development and project management lifecycle. It also relates to computing input/output parameters (such as skill, proficiency, size, complexity, effort, and cost for performing automated what-if analysis). Additionally, this disclosure relates to dynamic selection of a neural estimation model based on consideration of industry domain, technology, and other real time dependent factors of the software project development.

### BACKGROUND

Estimation is an important step in the process of any software product development. The end objective of the software development lifecycle is to meet the user's expectations as closely as possible and to spend a minimal amount of effort in the development of a product which is reasonably error-free. The effort to be spent on the development of the product may be estimated using the process of software development effort estimation (EE) and may be expressed in terms of person-hours and/or money. The effort estimates may then be used as input to project plans, iteration plans, budgets, investment analyses, pricing processes, and bidding rounds. Generally, the effort estimation is a very time-consuming process with many uncertainties. Additionally, existing techniques for estimation devote little attention to the effort estimation of given task types, as well as real business and technology complexity factors.

During the past decade, the software industry has undergone explosive growth fueled by tenfold increase in computer technology applications (Peled 1987, Cusumano 1991). The business dynamics have also changed from large deployments to minimum viable product (MVP) based deployments to accommodate frequently changing customer needs. These changes complicate the process of building a comprehensive estimation model that is easy to use with accurate results.

In industry, software development projects often begin with estimating costs and timelines based on factors like requirements, technologies, infrastructure, methods, and skills. These estimates are used for planning the staffing and schedule for the software development. Oftentimes software development projects go over budgets and fail to meet deadlines. Thus, organizations are stuck spending extra money and time on the projects.

Conventional project estimation involves formula-based linear estimation models based on productivity, component counts, technology, and industry type. These models lack the ability to predict estimation of effort and cost of software development with high accuracy as these models do not account for various dynamic complexities of business and technology. Additionally, these models require frequent manual calibration.

Accordingly, there is a need to improve estimation in software projects and classify the requirements to avoid human errors and bias and to compute more accurate estimation of the effort required to develop software or modify software. However, achieving accurate software estimation is a daunting task. Software estimation is highly complex, particularly since the relationships between software output metrics and contributing factors generally exhibit strong, complex, nonlinear characteristics. Accurate software estimation also typically requires the consideration of many factors, some of which can be difficult to quantify. Approaches used to solve this problem have not been widely successful in effectively and consistently predicting software output metrics.

There is a need in the art for a system and method that addresses the shortcomings discussed above.

### SUMMARY

A system and method for estimating software project delivery details is disclosed. The disclosed method and system accurately predicts project delivery details (e.g., person-days, effort, full-time equivalent (FTE), etc.) from input text (e.g., text describing a software project requirements) and project input parameters (e.g., variables, such as logical entities, transactions, individual/team proficiency, team level, duration of project, technology, industry domain, etc.) corresponding to a project scenario. The system and method solve the problems discussed above by using a complexity embedding engine, complexity classification engine, and dynamic model selection engine to generate inputs to an estimation engine that accurately captures the complexities of a project use case scenario, such that the estimation engine can accurately predict project delivery details. Additionally, the estimation engine itself uses this input to accurately predict project delivery details with little training.

The system may include a complexity embedding engine that transforms the input text into a context embedding neural vector (CENV) and word embedding neural vector (WENV) that can be averaged to generate an average embedding vector. A complexity classification engine may process the average embedding vector to classify the complexity of the use case requirements/use case scenario described in the input text. The complexity classification engine may require less training time than a standard activation function and provides higher accuracy. The complexity score output by the complexity classification engine may provide accurate input that may be ingested by an estimation engine.

The system and method may include using a dynamic model selection engine to select hyperparameters for use in training a neural estimation model used by estimation engine. With the complexity classification, hyperparameters, and project input parameters as input, the estimation engine can train and use a neural estimation model to accurately predict project delivery details.

In addition to predicting project delivery details, the disclosed system and method can provide a what-if analysis engine that allows a user to understand the possibilities of project scenarios having certain output. For example, a user can input desired project delivery output and the what-if analysis engine can generate the text input and/or project parameters necessary to achieve the desired project delivery output. Additionally, the what-if analysis engine can allow a user to try different inputs to observe how the inputs affect the project delivery output.

The disclosed methods and systems may be used for efficient project planning, including what-if analysis, task allocation, budget allocation, revenue forecasting and pricing estimation. The disclosed methods and systems may further aid software organizations in providing accurate, timely, and predictable product deliveries, predictable cost and schedule estimates, and reduced time to market for their customers. All these results may be achieved with the use of deep learning and rule-based context and word embedding and semantic validation technologies from natural language text.

In one aspect, the disclosure provides a computer-implemented method for estimating software project delivery details. The method includes receiving input text describing software project requirements and input project parameters for the software project. The method includes automatically processing the input text to generate a Context Embedding Neural Vector (CENV) and a Word Embedding Neural Vector (WENV). The method includes automatically averaging the CENV and WENV to generate a vector average. The method includes automatically processing the vector average by a complexity classifier engine to generate a complexity score. The method includes automatically using the complexity score and input project parameters to determine internal parameters for a neural estimation model of an estimation engine. The method includes automatically processing the input project parameters by a dynamic selection engine to determine hyperparameters for the neural estimation model. The method includes automatically using the determined internal parameters and the determined hyperparameters with the neural estimation engine to predict an estimation output.

In another aspect, the disclosure provides a system for estimating project delivery details. The system includes a processor and machine-readable media including instructions which, when executed by the processor, cause the processor to: (1) automatically receive input text describing software project requirements and input project parameters for the software project; (2) automatically process the input text to generate a Context Embedding Neural Vector (CENV) and a Word Embedding Neural Vector (WENV); (3) automatically average the CENV and WENV to generate a vector average; (4) automatically process the vector average by a complexity classifier engine to generate a complexity score; (5) automatically use the complexity score and input project parameters to determine internal parameters for a neural estimation model of an estimation engine; (6) automatically process the input project parameters by a dynamic selection engine to determine hyperparameters for the neural estimation model; and (7) automatically use the determined internal parameters and the determined hyperparameters with the neural estimation engine to predict an estimation output. The numbering does not indicate order of operations.

In another aspect, the disclosure provides a non-transitory computer readable medium storing software that may comprise instructions executable by one or more computers which, upon execution, cause the one or more computers to: (1) automatically receive input text describing software project requirements and input project parameters for the software project; (2) automatically process the input text to generate a Context Embedding Neural Vector (CENV) and a Word Embedding Neural Vector (WENV); (3) automatically average the CENV and WENV to generate a vector average; (4) automatically process the vector average by a complexity classifier engine to generate a complexity score; (5) automatically use the complexity score and input project parameters to determine internal parameters for a neural estimation model of an estimation engine; (6) automatically process the input project parameters by a dynamic selection engine to determine hyperparameters for the neural estimation model; and (7) automatically use the determined internal parameters and the determined hyperparameters with the neural estimation engine to predict an estimation output. The numbering does not indicate order of operations.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of a system for project estimation, according to an embodiment.

FIG. 2 is a functional diagram of the system for estimating project delivery details, according to an embodiment.

FIG. 3 is a functional diagram of the complexity embedding engine, according to an embodiment.

FIG. 4 is a functional diagram of the complexity classification engine, according to an embodiment.

FIG. 5 is a functional diagram of the estimation engine, according to an embodiment.

FIG. 6 is a result of running the estimation engine, according to an embodiment.

FIG. 7 is a diagram of the process of what-if analysis engine, according to an embodiment.

FIG. 8 is a flowchart of a method for estimating project delivery details, according to an embodiment.

### DESCRIPTION OF EMBODIMENTS

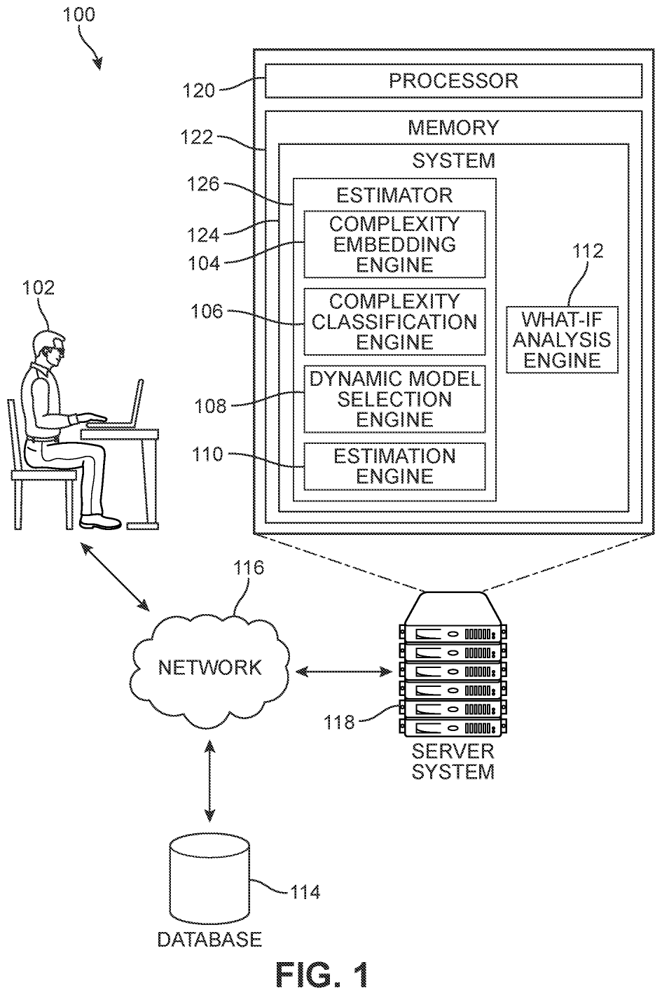

FIG. 1 is a schematic diagram of a system for project estimation 100 (or system 100), according to an embodiment. System 100 may include a user and user device 102 (or device 102 or user 102). During use, a user may interact with a system to estimate project delivery details, such as the duration and cost of the project.

The disclosed system for estimating project delivery details may include a plurality of components capable of performing the disclosed method (e.g., method 800). For example, system 100 includes a user device 102, a computing system 118, and a database 114. The components of system 100 can communicate with each other through a network 116. For example, user device 102 may retrieve information from database 114 via network 116. In some embodiments, network 116 may be a wide area network (“WAN”), e.g., the Internet. In other embodiments, network 116 may be a local area network (“LAN”).

While FIG. 1 shows one user device, it is understood that one or more user devices may be used. For example, in some embodiments, the system may include two or three user devices. In another example, in some embodiments, 10 user devices may be used. The user(s) may be workers entering input, such as project parameters or text describing project requirements, or the user(s) may be a worker utilizing the system to determine what parameters can provide different output than that provided based on the initial parameters given as input. In some embodiments, the user devices may be computing devices used by a user. For example, user device 102 may include tablet computers. In other examples, user device 102 may be a smart phone, a laptop computer, a desktop computer, or another type of computing device. The user devices may be used for inputting, processing, and displaying information.

As shown in FIG. 1, in some embodiments, a system for estimating project delivery details 124 may be hosted in a computing system 118. Computing system 118 includes a processor 120 and a memory 122. Processor 120 may include a single device processor located on a single device, or it may include multiple device processors located on one or more physical devices. Memory 122 may include any type of storage, which may be physically located on one physical device, or on multiple physical devices. In some cases, computing system 118 may comprise one or more servers that are used to host the system.

System 124 may include an estimator 126 and a what-if analysis engine 112. Estimator 126 may include a complexity embedding engine 104, a complexity classification engine 106, dynamic model selection engine 108, and an estimation engine 110.

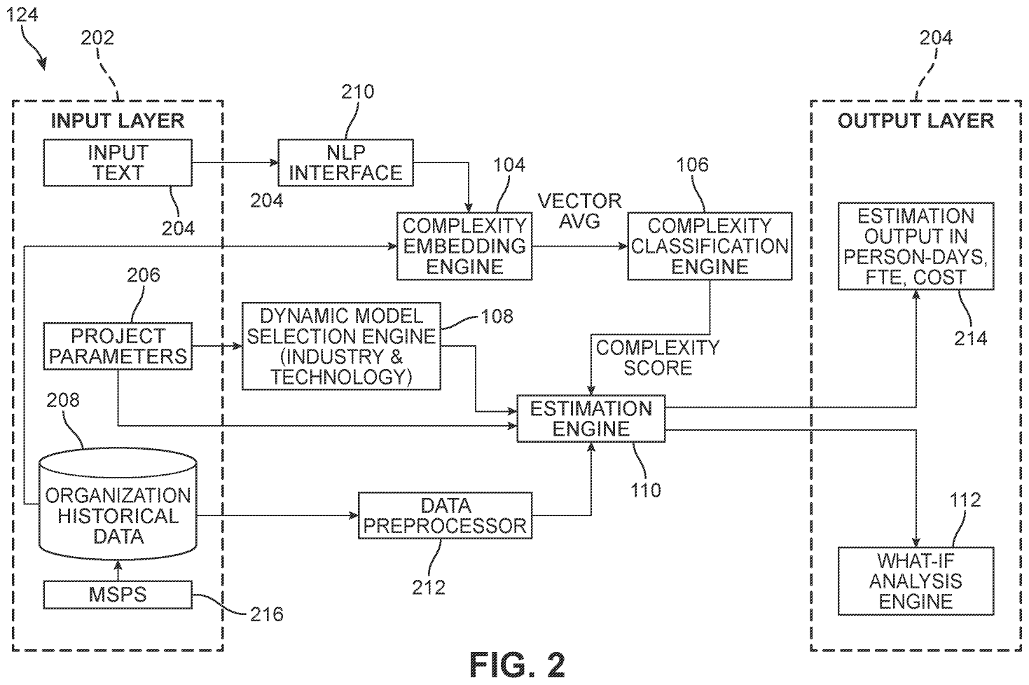

In some embodiments, users may utilize user device (e.g., computer or smartphone, etc.) to interact with the system to create, update, explore, and/or experiment with inputs affecting a project outcome via a natural language processing (NLP) interface that converts the user's utterances into messages that are useable by the other components of the system. For example, as shown in FIG. 2, user 102 may input text by uploading a document. In some embodiments, the user may interact with the system by communicating with a digital assistant (or chatbot), filling out an online form or template, responding to prompts, and/or uploading/inputting a text (e.g., a document) describing the project use case requirements. For example, in some embodiments, a virtual assistant or a webpage may prompt a user to insert parameters or text describing aspects of a project. In some embodiments, the user may insert parameters or project use case requirements by creating their own text. Additionally or alternatively, the user may make selections (e.g., from a pulldown menu or with radio buttons) for project parameters or project use case requirements. In some embodiments, the user may provide voice input. In such embodiments, the system may include a voice-to-text processor that performs natural language processing (NLP) on the voice input to convert the user's spoken words to text that can be used as input by the system.

In some example embodiments, the automated artificial intelligence infused model for predicting effort, cost and person-days estimates disclosed herein may be based on deep learning and machine learning technology selected dynamically based on industry domain and technology combination. The automated model based on deep learning and machine learning technology may be used for different stages of a software development lifecycle, such as, for example, requirement validation, requirement classification and effort estimation generation and for what-if analysis with an example can be of determining certainty of target parameters based on change in input parameters. In addition to predicting project output details, the system can also find relationships between inputs and outputs that help users understand how inputs can be altered to meet desired output metrics. For example, in some embodiments, the system may have a what-if analysis engine that allows a user to experiment with different scenarios to determine a scenario that fits the project needs.

FIG. 2 is a functional diagram of the system 124, according to an embodiment. System 124 has an input layer 202 and an output layer 204. The system 124 may be implemented in enterprises, such as an information technology (IT) enterprise or software solution enterprise for estimating efforts associated with new software projects or development of existing software projects or components of the same.

In some embodiments, as shown in FIG. 2, input layer 202 may include an input text 204, project parameters 206 (or input parameters 206), and/or organization historical data 208. Input text 204 may include text describing use case/project requirements, functionality of an application, and/or a use case scenario. For example, a document may include such text. Examples of project parameters 206 may include, but are not limited to, variables, such as logical entities, transactions, individual/team proficiency, team level, duration of project, technology, industry domain, etc. As discussed above, the user may enter input text and/or parameters by uploading/inputting a text (e.g., a document) describing the project use case requirements, communicating with a digital assistant (or chatbot), filling out an online form or template, and/or using an interface (e.g., Java-based interface). In some embodiments, the input text may be stored in cloud storage and/or enterprise storage.

The software project that is the subject of the estimation performed by the disclosed system and method may be based on agile software development method. Other software development models may be used such as, for example, a waterfall method, a rapid prototyping method, an incremental development method, a spiral method, and any other software development method.

Organization historical data 208 may be stored in a database. For example, in some embodiments, organization historical data 208 may be stored in a MySQL relational database service instance of Google Cloud Platform. Organization historical data 208 may include training data of input parameters, such as team proficiency, team level, duration of project, logical transactions, entities in data model, project size in unadjusted function points (e.g., as per International Function Point Users Group (IFPUG) and Function Point Analysis (FPA)), project complexity factor, project size in adjusted function points (e.g., as per IFPUG and FPA), technology factor, productivity time factor, business/priority value, and dependency factor. In some embodiments, information may be contributed to organization historical data 208 by a project management software system, such as Microsoft® Project Management Software (MSPS) or Microsoft Project Professional. For example, information may be contributed to organization historical data 208 by (MSPS) 216.

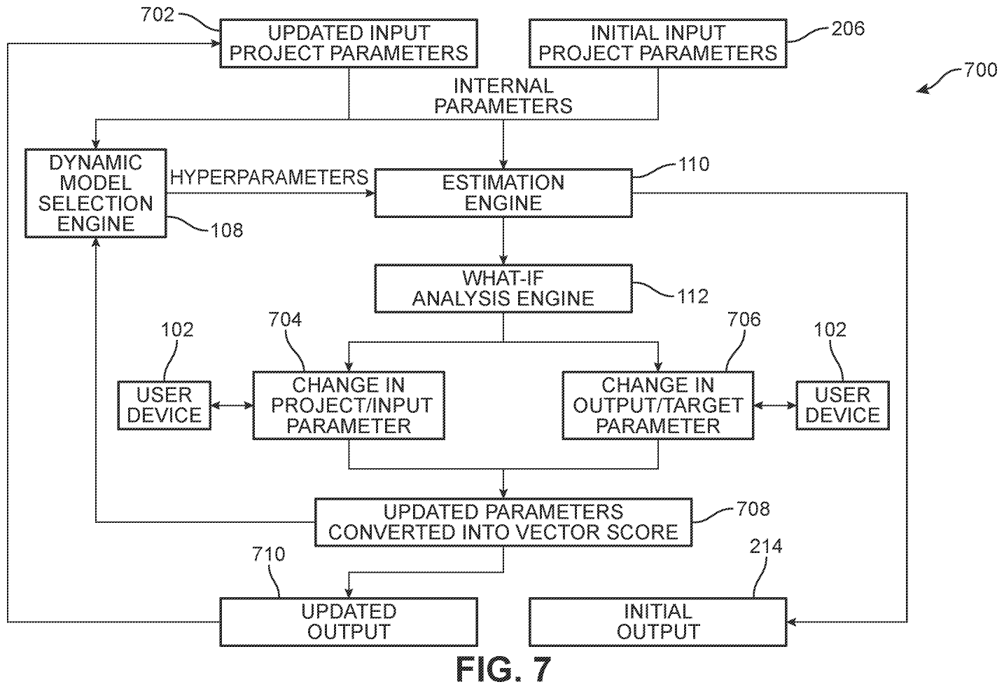

Output layer 204 may include estimation output 214 and output from what-if analysis engine 112. The estimation output may include delivery details of a project having certain requirements/plans described in the input text and characterized by the project parameters. The estimation output may be in the form of metrics describing delivery details. Examples of estimation output metrics include, but are not limited to, effort, cost, FTE, person-hours, and/or person-days. Output from what-if analysis engine 112 is discussed in more detail below with respect to FIG. 7.

The general flow of the system is now described, and details are provided below. As previously mentioned, a user may feed input text 204 into the system. In some embodiments, an NLP interface 210 may convert a user's utterances or text into messages that are useable by the other components of the system. The output from NLP interface 210 may be fed into complexity embedding engine 104. Additionally, organization historical data 208, which may be supplied by MSPS 216, may be fed into complexity embedding engine 104. Organization historical data 208 and output from NLP interface 210 may be used as input by complexity embedding engine 104 to create a vector that is the average of a context embedding neural vector (CENV) and a word embedding neural vector (WENV). The resulting vector can be fed to complexity classification engine 106, which uses the resulting vector to calculate a complexity score.

Project parameters 206, including technology and industry domain, may be fed into dynamic model selection engine 108. Dynamic model selection engine 108 can use project parameters 206 as input to select hyperparameters for use in estimation engine 110. For example, in some embodiments, dynamic model selection engine 108 can use a cluster technique on technology and industry domain value (e.g., SAP® in banking or SAP® in retail) to select hyperparameters for training estimation engine 110.

The above-mentioned complexity score along with project parameters 206 may be fed as input to estimation engine 110. For example, in some embodiments, the project parameters fed to estimation engine 110 may include logical entity and/or transaction. In some embodiments, organization historical data may be run through data preprocessor 212 and fed to estimation engine 110. Trained by hyperparameters selected by dynamic model selection engine 108, estimation engine 110 may use its inputs of complexity score, project parameters, and/or organization historical data to estimate outputs. For example, in some embodiments, estimation engine 110 may use neural regression to predict target parameters (estimation output 214). In some embodiments, target (or desired) parameters may include estimation output metrics, such as, predicted effort, cost, and/or person-days.

As mentioned, output layer 214 may include what-if analysis engine 112. The what-if analysis engine allows a user to select a certain estimation output and then finds parameters that can achieve this selected estimation output. For example, in some embodiments, what-if analysis engine 112 may enable a user to vary input or output of estimation engine 110 by a predetermined range in real time to assess impact of different business scenarios (e.g., change in scope, change in complexity, etc.).

The complexity embedding engine is now described in more detail. In some embodiments, the complexity embedding engine may embed input text (e.g., use case/project requirements and/or use case scenario) with context. For example, the complexity embedding engine can convert the input text to real-valued vectors in a predefined vector space.

Once the input text is received, the complexity embedding engine 104 may process the natural language text of input text 204 and embed input text 204 into intermediate vectors: CENV 312 and WENV 326, both corresponding to input text. For example, in some embodiments, the complexity embedding engine 104 may generate the WENV using token-id mapping and semantic feature hashing of words technique. The average of vector of CENV 312 and WENV 326 may be created as resultant vector 314 and then passed as input to complexity classification engine. Using an average of CENV and WENV helps address the situation in which two sentences have the same word vector by identifying the different context vectors of each of the two sentences. For example, assume sentence 1 is:
“create an ETL interface from vendor to client”
   and sentence 2 is:
“create an ETL interface from client to vendor.”

The word embeddings of these two sentences are identical although the contexts and complexities are different. This complexity embedding engine can create different vector embeddings for these two sentences: a CENV and a WENV.

In some embodiments, the complexity embedding engine may embed a CENV with custom semantic word lookup and an LSTM technique. In some embodiments, the complexity embedding engine may embed a WENV with token-id mapping and a semantic feature hashing of words technique. The vector average of vectors CENV and WENV may result in average embedding vector 314, which may be passed into complexity classification engine 106, which provides input to the estimation engine. The use of the average embedding vector in the estimation process can greatly improve accuracy by providing more detail about the use case requirements from the input text to complexity classification engine, which, in turn, provides more detail to the estimation engine.

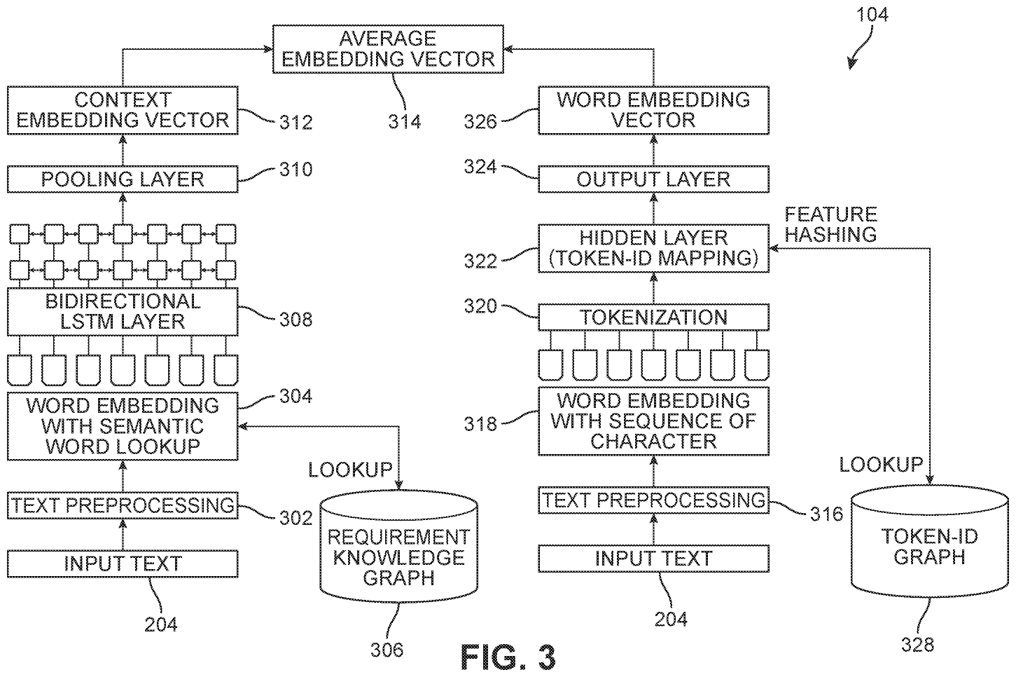

FIG. 3 is a functional diagram of complexity embedding engine 104, according to an embodiment. The left hand side of the diagram shows components and operations building CENV 312. The right hand side of the diagram shows components and operations building WENV 326. Separately converting the input text into CENV and WENV and then averaging the two improves classification accuracy. For example, during testing of this technique, averaging CENV and WENV improved accuracy of the classification by ˜30%-˜40% when compared with only embedding CENV.

To produce a CENV, a text preprocessor 302 may remove stop words and skewness and convert input text to a format that is useable by downstream components. For example, text preprocessor 302 may convert input text 204 to a word embedding with semantic word lookup 304. The complexity embedding engine may generate CENV by using semantic lookup and a bi-directional Long Short-Term Memory 308 (or LSTM 308). The output of the LSTM 308 may be reduced through a pooling layer 310, thereby generating CENV 312. The CENV may be a multi-dimensional vector. For example, in some embodiments, the CENV may be a 512 dimensional vector.

To produce a WENV, a text preprocessor 316 may convert input text to a format that is useable by downstream components. For example, text preprocessor 316 may remove stop words and skewness and convert input text 204 to a word embedding. For example, text preprocessor 302 may convert input text 204 to a word embedding with sequence of character 318. In some embodiments, the word complexity embedding engine may generate the WENV by using token-id mapping. In some embodiments, the word complexity embedding engine may generate the WENV by using semantic feature hashing of words technique. For example, at 320, word embedding with sequence of character 318 may be tokenized and passed to a hidden layer 322. The complexity embedding engine can use a hashing function with a semantic word lookup of each individual word from a token-ID graph to predict semantically similar vocabulary using entity-relationship model. Together token-id mapping and a semantic feature hashing of words technique may include removing punctuations and converting words into vectors to produce an output layer 324. For example, in some embodiments, the resultant word vectors have 512 dimensions. Output layer 324 may aggregate all the vectors of a given requirement sentence and produce a WENV. For example, Table 1 below shows an example of vectors created throughout this process.

TABLE 1
Example of Input and Vectors Created
By Operations to Build WENV

| Input | Vector Resulting | |
|---|---|---|
| Words | from Hash Function | Output WENV Vector |
| create | [00011] | [00011, 00001, 00111, 10001, |
| an | [00001] | 10000, 01001, 00101, 001010] |
| ETL | [00111] | |
| interface | [10001] | |
| from | [10000] | |
| vendor | [01001] | |
| to | [00101] | |
| client | [00110] | |

The WENV may be a multi-dimensional vector. For example, in some embodiments, the WENV may be a 512 dimensional vector. In some embodiments, the CENV and WENV may have the same number of dimensional vector.

In some embodiments, the average vector produced by complexity embedding engine 104 can be passed to complexity classification engine 106. The complexity classification engine can process the vector produced by the complexity embedding engine to classify the complexity of the use case requirements/use case scenario described in the input text.

The complexity classification engine will now be described in more detail. The complexity classification engine requires less training time than a standard activation function and provides higher accuracy. In one example, the complexity classification engine uses a customized binary search-based activation function which understands the nonlinear dynamic pattern of input and maps it to a classification output in the form of numerical value. The customized binary search-based activation function can transform multi-dimensional input vectors of a given project requirement into a complexity score (e.g., simple, medium, and/or complex).

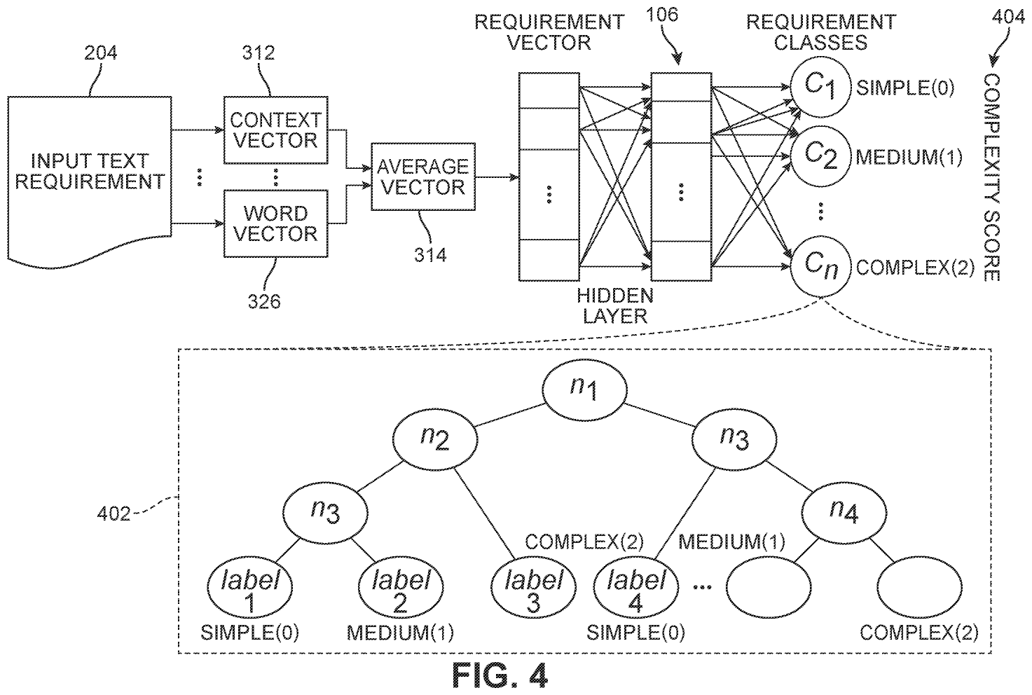

FIG. 4 is a functional diagram of complexity classification engine 106, according to an embodiment. As previously discussed with respect to FIG. 3, input requirement text 204 may converted to a context vector 312 and word vector 326, and the two vectors may be averaged to produce average vector 314. Average vector 314 may be input to a binary tree function 402 that can create an output vector comprising a conditional probability distribution of a plurality of classification answers associated with a plurality of input patterns identified from average vector 314. The generating may comprise of determining output as complexity score 404 being simple, medium, or complex in numerical number representation in relation with use case text of the requirement, wherein the complexity score 404 is indicative of a quality of the requirement.

Complexity classification engine 106 may include a supervised neural network classifier that is trained using labeled data to automatically recognize classes of use case requirements/use case scenarios. The supervised neural network classifier may then be trained to predict the labels given to the use case requirements/use case scenarios.

The neural network classifier may use a customized activation function that internally uses a binary tree customized for this application to compute probability density over predefined classes based on trained requirement vectors and labels. The customized activation function calculates the probability of Yn (label of n^{th} requirement) as each possible class and outputs probability estimates for each class. These probabilities sum to one and provide a means to choose the highest probability as the corresponding label for Yn. The probability of a certain class is then calculated as:

P(nₗ₌₁)=Åᵢ₌₁^{l}P(nᵢ),

where n represents the leaf node that a class is located on with depth (l+1) and n₁, n₂, . . . , nₗ represents the parent nodes of that leaf.

The dynamic model selection engine will now be described in more detail. As mentioned above, dynamic model selection engine 108 can use project parameters 206 as input to select hyperparameters for use in training the neural model used by estimation engine 110. More specifically, in some embodiments, dynamic model selection engine 108 can use the project parameters of industry domain and technology. Examples of industry domains include, but are not limited to, healthcare, banking, retail, and chemical. Examples of technology include, but are not limited to, SAP®, JAVA, MS .NET, and PYTHON.

In some embodiments, the hyperparameter values may be stored in cloud storage. In some embodiments, dynamic model selection engine 108 may dynamically select the hyperparameter values using a custom technique of clustering technology and industry domain matrix values. Examples of hyperparameters may include, but are not limited to, the number of layers, number of neurons, neuron activation functions, learning rate, batch size, etc. Hyperparameters of the model may be external to model both at the structure and topology level of the neural network and at the learning algorithm level (e.g., learning rate, momentum, epochs, batch size, etc.). Hyperparameters of the model may be determined automatically at runtime based on technology and industry domain input provided for given use case requirements/use case scenario. The saved model hyperparameters may be selected dynamically to overwrite the runtime model parameters based on an application programming interface (API) call after parsing technology and industry domain parameters.

Typically, hyperparameters are set by a programmer in code or from a backend server, which requires release of new version of the software to make the change affect. Unlike this complicated, slower process, the dynamic model selection engine of the disclosed system may include a cloud-based service which enables selection of saved model hyperparameters without requiring for a new software release or update from user.

The dynamic selection based on technology and industry domain, can happen in milliseconds without negatively impacting performance. The estimation accuracy of the system is improved with the use of dynamic model selection engine.

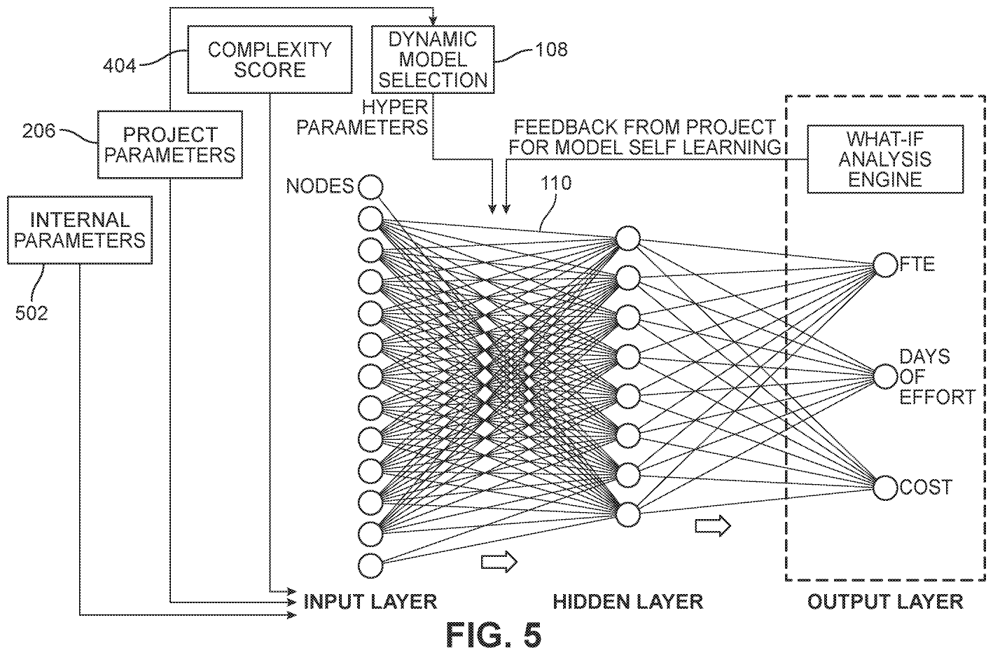

The estimation engine will now be described in more detail. FIG. 5 is a functional diagram of the estimation engine 110, according to an embodiment. Estimation engine 110 may include a neural model. For example, in some embodiments, the estimation engine may include a multiple hidden layer-based regression neural model. As shown in FIG. 5, multiple inputs may be used to train the neural model of the estimation engine. For example, project parameters 206, complexity score 404, and hyperparameters from dynamic model selection 108 may be inputs used to train the neural model of the estimation engine. Examples of project parameters used to train the estimation engine may include, but are not limited to, logical entity and transaction. In some embodiments, the project parameters, complexity score 404, other user input parameters (e.g., team proficiency, team level, duration of the project, logical transactions, entities in data model, etc.) directly pulled from organization historical data 208 and/or MSPS, and dynamically selected model hyperparameters are input for a multiple hidden layer-based regression neural model to predict estimation output (e.g., cost, FTE, and/or person-days).

The input to the estimation engine may be used to create runtime internal parameters (i.e., weights and bias) for the estimation neural model. For example, in some embodiments, the complexity score and the project parameters may be used to create the internal parameters. In some embodiments, the neural estimation model may use the internal parameters (i.e., weights and bias) and hyperparameters to train to predict estimation output. After training, the neural estimation model can perform a series of steps comprising passing the input data (i.e., internal parameters (i.e., weights and bias) and hyperparameters) from a first layer and a hidden layer to a second layer of the neural estimation model to predict output in effort, person-days, and cost. For example, in some embodiments, the estimation neural model uses the following for prediction:

y(i)=φ[w(i)x(i)+b(i)],

where y(i) is vectorized output of layer i, w is the vectorized weights assigned to neurons of hidden layer, and x is the vectorized input features, b is the vectorized bias assigned to neurons in hidden layer (i.e., b1 and b2), and φ is the activation function which represents complex patterns in the data. In an exemplary embodiment in which the neural estimation model is a single layer neural network regression model, the estimation neural model may use the following for prediction,

y(i)=φ[w(i)x(i)+b(i)],

where y(1) is vectorized output of layer 1, w is the vectorized weights assigned to neurons of hidden layer (i.e., w1, w2, w3, and w4), and x is the vectorized input features (i.e., i1 and i2), b is the vectorized bias assigned to neurons in hidden layer (i.e., b1 and b2), and φ is the activation function which represents complex patterns in the data. The prediction output represents the metrics of project delivery details corresponding to the project requirements based on the relationship pattern on the given set of input parameters. In some embodiments, the estimation engine may provide a certainty score with the output (e.g, certainty score can be a probability that estimation is correct). The neural estimation model may include continuous self-learning based on feedback from real project output (e.g., effort, cost, person-days, etc.) resulting from a set of input parameters. The estimation engine may send estimation output 214 to a remote display on user device 102.

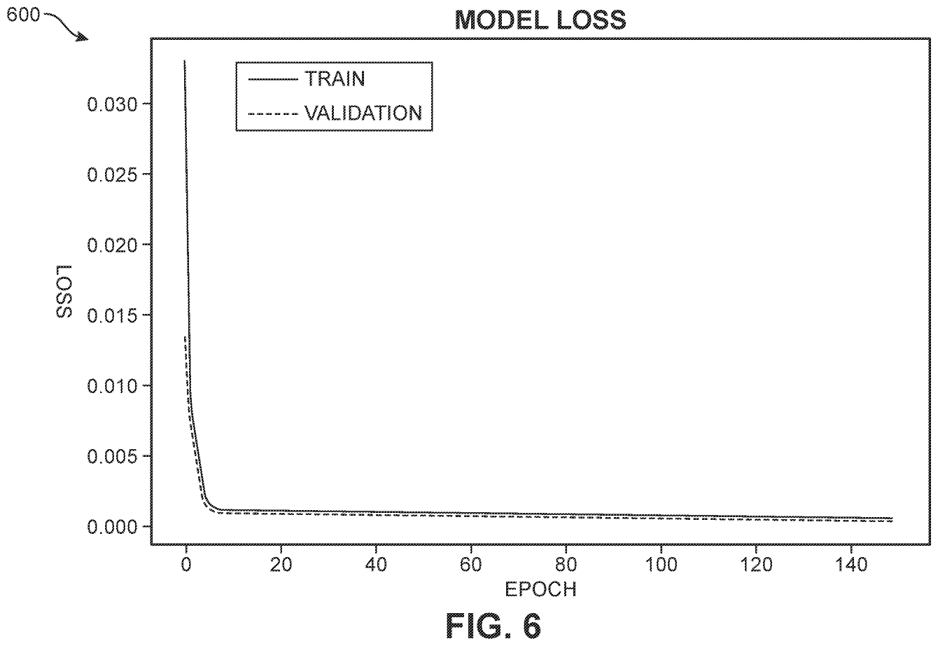

FIG. 6 is a result 600 of running the estimation engine, according to an embodiment. Embodiments of the disclosed method have provided consistent high accuracy output in repeated run. In the example run of FIG. 6, training and validation loss decrease rapidly. In the prototype used to create result 600, 80% of the training data was used to test the neural estimation model, while the remaining 20% is used for testing purposes. The more epochs ran, the lower the mean error squared and mean absolute error became, indicating improvement in accuracy across each iteration of the model. Keras was used calculating both the training loss and validation loss (i.e., the deviation between the predicted y and actual y as measured by the mean squared error).

The what-if analysis engine will now be described in more detail. FIG. 7 is a diagram of the process of what-if analysis engine 700, according to an embodiment. In some embodiments, the automated AI infused model computes the input/output parameters such as skill, proficiency, size, complexity, effort, and cost for performing automated what-if analysis.

The what-if analysis engine can be used to experiment with different project scenarios by varying/updating project/input or output/target parameters by a predetermined range. In other words, the what-if analysis engine may allow a user (e.g., a project manager) to perform estimation-related simulations of various scenarios by adjusting input and/or output of the system for estimating project delivery details. For example, in some embodiments, what-if analysis engine 112 can determine a certainty score of achieving the project delivery with the estimation output metrics (e.g., effort, cost, person-days) given a set of input parameters (e.g., entity, transaction, and/or technology) using the neural estimation model. In some embodiments, the what-if analysis engine may import a saved neural estimation model from cloud backend storage to remote cache storage, thus enabling a user to vary input or output parameters of the saved estimation model by a predetermined range in real time to assess the impact of different project scenarios.

To perform real time simulations of different business scenarios, a user may change input or output parameters (e.g., change in scope and/or change in complexity). The what-if analysis engine may convert the change in input or output parameters into a vector score for the respective parameters. In some embodiments, the vector score may be multiplied with input parameters and input into the estimation engine. The estimation engine uses this multiplied input to determine updated output parameters (e.g., in effort, cost, person-days) with a certainty score. In some embodiments, the vector score may be multiplied with initial output parameters. The same estimation model may provide a recommendation of keeping optimal input parameter mix to achieve the given certainty score with target output parameter of a software project. In other words, the user can use the what-if engine to see in real time how changing an input parameter effects the output. Similarly, the user can use the what-if engine to see in real time how a particular target output effects what input parameters are necessary to achieve the target output.

In an example of using the what-if analysis engine, the below independent variables and target variables listed in Table 2 may be used for training and testing the neural estimation model.

TABLE 2
Example of Train/Test Variables

| | |
|---|---|
| Independent Variables | Target Variable |

| Logical Entities | Transactions | Effort in Days |
|---|---|---|
| 10 | 1000 | 45 |
| 8 | 900 | 30 |
| 17 | 1500 | 61 |

In such an example, a user, such as a project manager, may want to know what estimation would be predicted for a project scenario with the independent variables shown below in Table 3.

TABLE 3
Variables of Example Project Scenario (Changing Input)

| | |
|---|---|
| Independent Variables | Target Variable |

| Logical Entities | Transactions | Effort in Days |
|---|---|---|
| 14 | 1100 | To Predict |

[Vector[14], Vector [1100]] may be shared as an updated input vector. In such an example, the what-if analysis engine may allow the user to input the independent variables and the what-if analysis engine may estimate that the project scenario with these independent variables may require 40 days of effort. Following the same example, the user may not be satisfied with 40 days and may prefer 30 days with 900 transactions. In such a case, the user can input 30 days for effort and 900 for the number of transactions, as shown below in Table 4.

TABLE 4
Variables of Example Project Scenario (Changing Output)

| | |
|---|---|
| Independent Variables | Target Variable |

| Logical Entities | Transactions | Effort in Days |
|---|---|---|
| To Predict | 900 | 30 |

[Vector[900], Vector [30]] may be shared as an updated input vector. In such an example, the what-if analysis engine may estimate that the project scenario with 30 effort in days and 900 transactions will require 8 logical entities.

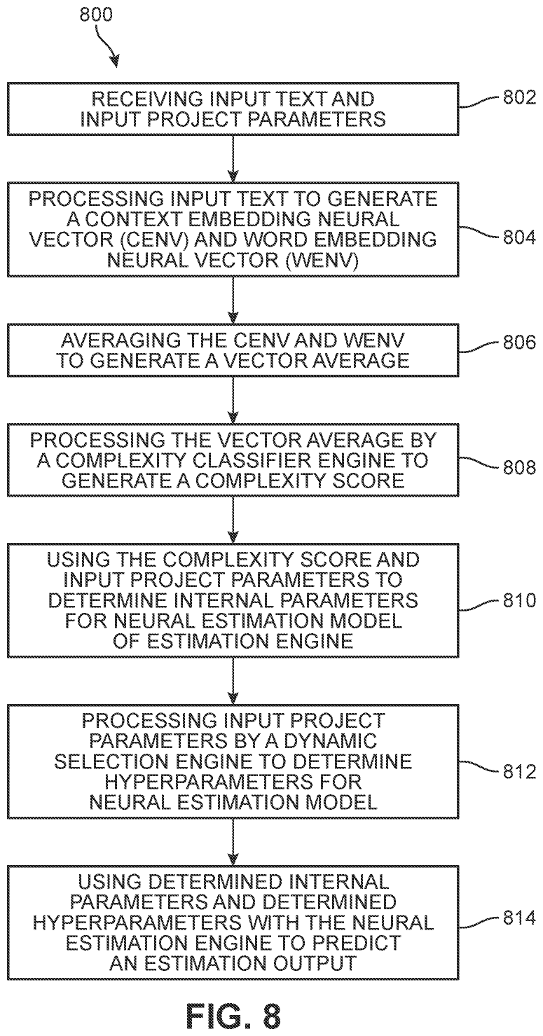

FIG. 8 is a flowchart of a method 800 for estimating project delivery details, according to an embodiment. Method 800 may include receiving input text and input project parameters (operation 802). Method 800 may include processing input text to generate a Context Embedding Neural Vector (CENV) and Word Embedding Neural Vector (WENV) (operation 804). Method 800 may include averaging the CENV and WENV to generate a vector average (operation 806). For example, operations 804 and 806 may include the processes discussed above with respect to FIG. 3. Method 800 may include processing the vector average by a complexity classifier engine to generate a complexity score (operation 808). For example, operation 808 may include the processes discussed above with respect to FIG. 4. Method 800 may include using the complexity score and input project parameters to determine internal parameters for neural estimation model of estimation engine (operation 810). Method 800 may include processing input project parameters by a dynamic selection engine to determine hyperparameters for neural estimation model (operation 812). Method 800 may include using determined internal parameters and determined hyperparameters with the neural estimation engine to predict an estimation output (operation 814). For example, operations 810, 812, and 814 may include the processes discussed above with respect to FIG. 5. In some embodiments, method 800 may further include the processes discussed above with respect to FIG. 7.

It should be understood that the systems and/or methods as described herein may be implemented using different computing systems, components, modules, and connections. For example, a user device may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, user device may receive information from and/or transmit information to the policy management service platform. For example, a device may include a bus, a processor, a memory, a storage component, an input component, an output component, and a communication interface.

The bus will include a component that permits communication among the components of the device. The processor is implemented in hardware, firmware, or a combination of hardware and software. The processor is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, a processor includes one or more processors capable of being programmed to perform a function. Memory includes a random access memory (RAM), a read only memory (ROM), and/or another type of dynamic or static storage device (e.g., a flash memory, a magnetic memory, and/or an optical memory) that stores information and/or instructions for use by a processor(s).

In addition, storage components store information and/or software related to the operation and use of the device. For example, storage components may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Furthermore, an input component includes a component that permits the device to receive information, such as via user input (e.g., a touch screen display, a keyboard, a keypad, a mouse, a button, a switch, and/or a microphone). Additionally, or alternatively, input components may include a sensor for sensing information (e.g., a global positioning system (GPS) component, an accelerometer, a gyroscope, and/or an actuator). The output component includes a component that provides output information from a device (e.g., a display, a speaker, and/or one or more light-emitting diodes (LEDs)).

A communication interface includes a transceiver-like component (e.g., a transceiver and/or a separate receiver and transmitter) that enables a device to communicate with other devices, such as via a wired connection, a wireless connection, or a combination of wired and wireless connections. The communication interface may permit the device to receive information from another device and/or provide information to another device. For example, a communication interface may include an Ethernet interface, an optical interface, a coaxial interface, an infrared interface, a radio frequency (RF) interface, a universal serial bus (USB) interface, a Wi-Fi interface, a cellular network interface, and/or the like.

Thus, the device may perform one or more processes described herein. The device may perform these processes based on processor executing software instructions stored by a non-transitory computer-readable medium, such as memory and/or storage component. A computer-readable medium is defined herein as a non-transitory memory device. A memory device includes memory space within a single physical storage device or memory space spread across multiple physical storage devices.

Software instructions may be read into memory and/or storage components from another computer-readable medium or from another device via communication interface. When executed, software instructions stored in memory and/or storage component may cause processor to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

In some implementations, a policy management service may be hosted in a cloud computing environment. Notably, while implementations described herein describe a policy management service as being hosted in cloud computing environment, in some implementations, a policy management service may not be cloud-based (i.e., may be implemented outside of a cloud computing environment) or may be partially cloud-based.

Cloud computing environment can include, for example, an environment that hosts the policy management service. The cloud computing environment may provide computation, software, data access, storage, etc. services that do not require end-user knowledge of a physical location and configuration of system(s) and/or device(s) that hosts the policy management service. For example, a cloud computing environment may include a group of computing resources (referred to collectively as “computing resources” and individually as “computing resource”).

Computing resources includes one or more personal computers, workstation computers, server devices, or other types of computation and/or communication devices. In some implementations, computing resources may host the policy management service. The cloud resources may include compute instances executing in computing resource, storage devices provided in computing resource, data transfer devices provided by computing resource, etc. In some implementations, computing resource may communicate with other computing resources via wired connections, wireless connections, or a combination of wired and wireless connections. In some embodiments, a computing resource includes a group of cloud resources, such as one or more applications (“APPs”), one or more virtual machines (“VMs”), virtualized storage (“VSs”), one or more hypervisors (“HYPs”), and/or the like.

Application includes one or more software applications that may be provided to or accessed by user devices. Application may eliminate a need to install and execute the software applications on a user device. For example, an application may include software associated with the policy management service and/or any other software capable of being provided via cloud computing environment, while in some embodiments, other applications are provided via virtual machines. A virtual machine can include a software implementation of a machine (e.g., a computer) that executes programs like a physical machine. A virtual machine may be either a system virtual machine or a process virtual machine, depending upon use and degree of correspondence to any real machine by virtual machine. A system virtual machine may provide a complete system platform that supports execution of a complete operating system (“OS”). A process virtual machine may execute a single program and may support a single process. In some embodiments, virtual machines may execute on behalf of a user (e.g., a user of user device or an administrator of the policy management service), and may manage infrastructure of cloud computing environment, such as data management, synchronization, or long-duration data transfers.

Virtualized storage includes one or more storage systems and/or one or more devices that use virtualization techniques within the storage systems or devices of computing resources. In some embodiments, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisors may provide hardware virtualization techniques that allow multiple operating systems (e.g., “guest operating systems”) to execute concurrently on a host computer, such as a computing resource. Hypervisors may present a virtual operating platform to the guest operating systems and may manage the execution of the guest operating systems. Multiple instances of a variety of operating systems may share virtualized hardware resources.

A network includes one or more wired and/or wireless networks. For example, networks may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

We claim:

1. A computer-implemented method for estimating software project delivery details, the computer-implemented method comprising:
receiving input text describing software project requirements and input project parameters for the software project;
automatically processing the input text to generate a Context Embedding Neural Vector (CENV) and a Word Embedding Neural Vector (WENV);
automatically averaging the CENV and WENV to generate a vector average;
automatically processing the vector average by a complexity classifier engine to generate a complexity score;
automatically using the complexity score and input project parameters to determine internal parameters for a neural estimation model of an estimation engine;
automatically processing the input project parameters by a dynamic selection engine to determine hyperparameters for the neural estimation model; and
automatically using the determined internal parameters and the determined hyperparameters with the neural estimation engine to predict an estimation output.

2. The computer-implemented method of claim 1, wherein the estimation output includes one or more of cost, person-days, person-hours, and effort.

3. The computer-implemented method of claim 1, wherein the input project parameters include one or more of logical entities, transactions, individual proficiency, team proficiency, team level, duration of project, technology, and industry domain.

4. The computer-implemented method of claim 3, wherein processing the input project parameters by a dynamic selection engine includes clustering the input project parameters of technology and industry.

5. The computer-implemented method of claim 1, wherein the complexity classification engine uses a customized binary search-based activation function.

6. The computer-implemented method of claim 1, wherein the neural estimation model includes a multiple hidden layer-based regression neural model and wherein using the determined internal parameters and the determined hyperparameters with the neural estimation engine includes a series of steps comprising passing the internal parameters and hyperparameters from a first layer and a hidden layer to a second layer of the neural estimation model to predict output in effort, person-days, and cost.

7. The computer-implemented method of claim 1, further comprising;
automatically using a what-if analysis engine to vary input parameters or output parameters by a predetermined range of the custom neural estimation model to assess impact of different business scenarios.

8. A system for estimating project delivery details, the system comprising:
a processor;
machine-readable media including instructions which, when executed by the processor, cause the processor to:
automatically receive input text describing software project requirements and input project parameters for the software project;
automatically process the input text to generate a Context Embedding Neural Vector (CENV) and a Word Embedding Neural Vector (WENV);
automatically average the CENV and WENV to generate a vector average;
automatically process the vector average by a complexity classifier engine to generate a complexity score;
automatically use the complexity score and input project parameters to determine internal parameters for a neural estimation model of an estimation engine;
automatically process the input project parameters by a dynamic selection engine to determine hyperparameters for the neural estimation model; and
automatically use the determined internal parameters and the determined hyperparameters with the neural estimation engine to predict an estimation output.

9. The system of claim 8, wherein the estimation output includes one or more of cost, person-days, person-hours, and effort.

10. The system of claim 8, wherein the input project parameters include one or more of logical entities, transactions, individual proficiency, team proficiency, team level, duration of project, technology, and industry domain.

11. The system of claim 10, wherein processing the input project parameters by a dynamic selection engine includes clustering the input project parameters of technology and industry.

12. The system of claim 8, wherein the complexity classification engine uses a customized binary search-based activation function.

13. The system of claim 8, wherein the neural estimation model includes a multiple hidden layer-based regression neural model and wherein using the determined internal parameters and the determined hyperparameters with the neural estimation engine includes a series of steps comprising passing the internal parameters and hyperparameters from a first layer and a hidden layer to a second layer of the neural estimation model to predict output in effort, person-days, and cost.

14. The system of claim 8, wherein the instructions further cause the processor to;
automatically use a what-if analysis engine to vary input parameters or output parameters by a predetermined range of the custom neural estimation model to assess impact of different business scenarios.

15. A non-transitory computer-readable medium storing software comprising instructions executable by one or more computers which, upon such execution, cause the one or more computers to:
automatically receive input text describing software project requirements and input project parameters for the software project;
automatically process the input text to generate a Context Embedding Neural Vector (CENV) and a Word Embedding Neural Vector (WENV);
automatically average the CENV and WENV to generate a vector average;
automatically process the vector average by a complexity classifier engine to generate a complexity score;
automatically use the complexity score and input project parameters to determine internal parameters for a neural estimation model of an estimation engine;
automatically process the input project parameters by a dynamic selection engine to determine hyperparameters for the neural estimation model; and
automatically use the determined internal parameters and the determined hyperparameters with the neural estimation engine to predict an estimation output.

16. The non-transitory computer-readable medium storing software of claim 15, wherein the estimation output includes one or more of cost, person-days, person-hours, and effort.

17. The non-transitory computer-readable medium storing software of claim 15, wherein the input project parameters include one or more of logical entities, transactions, individual proficiency, team proficiency, team level, duration of project, technology, and industry domain.

18. The non-transitory computer-readable medium storing software of claim 16, wherein processing the input project parameters by a dynamic selection engine includes clustering the input project parameters of technology and industry.

19. The non-transitory computer-readable medium storing software of claim 15, wherein the complexity classification engine uses a customized binary search-based activation function.

20. The non-transitory computer-readable medium storing software of claim 15, wherein the neural estimation model includes a multiple hidden layer-based regression neural model and wherein using the determined internal parameters and the determined hyperparameters with the neural estimation engine includes a series of steps comprising passing the internal parameters and hyperparameters from a first layer and a hidden layer to a second layer of the neural estimation model to predict output in effort, person-days, and cost.
